(19) United States
(12) Patent Application Publication
(10) Pub. No.: US 2014/0377732 A1
(43) Pub. Date: Dec. 25, 2014

(54) METHOD AND SYSTEM FOR PROVIDING VIDEO PATHWAYS WITHIN AN ONLINE COURSE

(71) Applicants: Gordon L. Freedman, Carmel, CA (US); Gordon Sean Freedman, Collingwood, CA (US)

(72) Inventors: Gordon L. Freedman, Carmel, CA (US); Gordon Sean Freedman, Collingwood, CA (US)

(21) Appl. No.: 14/312,240

(22) Filed: Jun. 23, 2014

Related U.S. Application Data
(60) Provisional application No. 61/838,078, filed on Jun. 21, 2013.

(51) Int. Cl. G09B 5/10; G09B 5/02

(52) U.S. Cl. CPC G09B 5/10; G09B 5/02
USPC 434/322; 434/365

(57) ABSTRACT

An online school provides video courses to students that are made up of an unordered group of video segments. The path sequence and quantity of the video segments from the group displayed to each student may be different and are determined by various factors including the student's previous knowledge, style of learning and course criteria.

### CROSS REFERENCE

This application claims the benefit under 35 U.S.C. §119(e) of U.S. Provisional Application No. 61/838,078, filed on Jun. 21, 2013 which is hereby incorporated by reference in its entirety.

### FIELD OF THE INVENTION

The invention relates to streaming video and more particularly to streaming video with multiple pathways.

### BACKGROUND

In Buddhist philosophy, it is important to take the time to find the right master. The right master can lead you down the shortest path to enlightenment. Thus, for each student, a different path is the best for learning and growing.

A similar philosophy can be applied to education. Not every student is best served by learning in the same way. A good teacher should identify what a student needs and help them most effectively and efficiently learn the material. Unfortunately, in today's factory based education system, this is often impossible. To make matters worse, educational resources are seeking to become even more mass oriented with massive open online courses (MOOCs). MOOCs aim to use streaming video and audio to transmit educational classes via the Internet to millions of students. Thus, the current trends point away from more effective and efficient learning to more efficient teaching. Further, the MOOC methodology is more focused on student lead learning—forcing students to learn how to learn.

It would be advantageous to provide a method and system that overcomes these and other drawbacks of the prior art.

### SUMMARY

In accordance with the invention there is provided a method comprising providing a first plurality of video segments and a second plurality of video segments to form a course, wherein the first plurality of segments is absent one video segment of the second plurality of video segments; arranging the first plurality of video segments sequentially to form a first pathway; arranging the second plurality of video segments sequentially to form a second pathway; providing the course to a first user comprising displaying the first pathway to the first user; and providing the course to a second user comprising displaying the second pathway to the second user, wherein the course comprises same material to be taught to each of the first and second users.

In accordance with an embodiment of the invention there is provided a method comprising: providing a plurality of students including a first student and first group of students; providing a plurality of courses in a video format and comprising a plurality of video segments, at least some of the courses having more than one pathway each comprising at least a different video segment; for each of the plurality of students, storing data relating to performance on each of a plurality courses; and determining one of at least two pathways for teaching a same course to a first student, the one of at least two pathways determined based on historical performance of a first group of students on the one of at least two pathways, the first group of students similar to the first student.

In accordance with an embodiment of the invention there is provided a method comprising: providing a plurality of students including a first student and first group of students; providing a plurality of courses in a video format and comprising a plurality of video segments, at least some of the courses having more than one pathway each comprising at least a different video segment; for each of the plurality of students, storing data relating to performance on each of a plurality courses; and determining at least a first remediation video segment for the course for the first student, the remediation video segment determined based on historical performance of a first group of students in the course, the first group of students similar to the first student.

### BRIEF DESCRIPTION OF THE FIGURES

Embodiments of the invention will now be described with reference to the drawings in which like numbered elements are similar and in which:

FIG. 1 is a simplified general block diagram of an exemplary computing environment.

FIG. 2 is a simplified diagram of a video course supporting pathways.

FIG. 3 is a simplified flow diagram of a method of switching between pathways.

FIG. 4 is a course diagram comprising of multiple pathways and a student's recommended pathway is based on a condition.

FIG. 5 is a simplified video course segment diagram comprising three different pathways.

FIG. 6 is a simplified video course segment diagram comprising a plurality of different pathways.

FIG. 7 is a simplified diagram of a video course according to an embodiment of the invention.

FIG. 8 is a simplified flow diagram of students dynamically adding new pathways to a course and associating a rating to the new pathway.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

Using video editing software, a user—a video editor—selects a plurality of video clips and for each video clip selects a start point and an end point. The clips between the start point and end point of each are then assembled into a single video event from start to finish. For example, a television show, a video-blog, or a film are typically edited in this way. Video editing software is now available for personal computers, tablets, and even smart phones. It is used by many millions of people around the world and results in many millions of videos including scene changes or multiple angles.

Using video editing software, clips can also be “adjusted.” Audio levels can be varied as can lighting. Text can be overlaid onto video segments and sound can be “dubbed.” Scene changes can be accented with fade ins and outs and other fancy transitions. That said, video editing inevitably leads to a single video production going from a start to a finish along a known path.

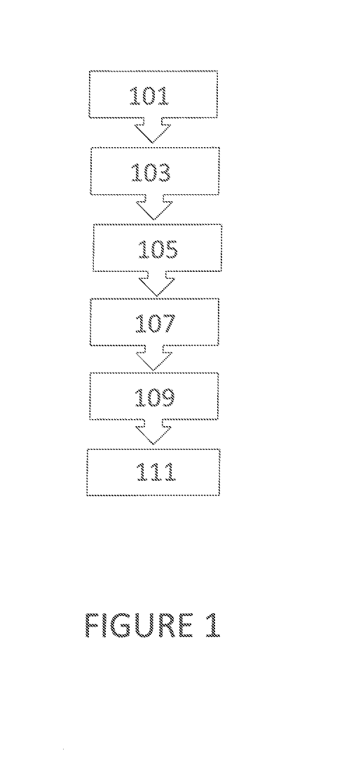

Referring to prior art FIG. 1, shown is a simplified flow diagram of a method of video assembly according to the prior art. At 101 a video editor retrieves a plurality of video segments on a computer to compose a single continuous video comprised of some, if not all, of the plurality of video segments. Organizing the order of the video segments at 103, the video editor uses video editing software to arrange the video segments sequentially in time. At 105 the video editor “stitches” the video segments together to form a single continuous video when played by a viewer. Text is overlaid onto the single continuous video at 107 and at 109 the video editor records an audio sound track and integrates it with the single continuous video. Alternatively, the audio originally recorded with each video segment is used. Alternatively, text is overlaid onto the individual video segments and audio is integrated with the video segments prior to “stitching” the video segments together. At 111 the video editor views the single continuous video comprising video clips, overlaid text and audio.

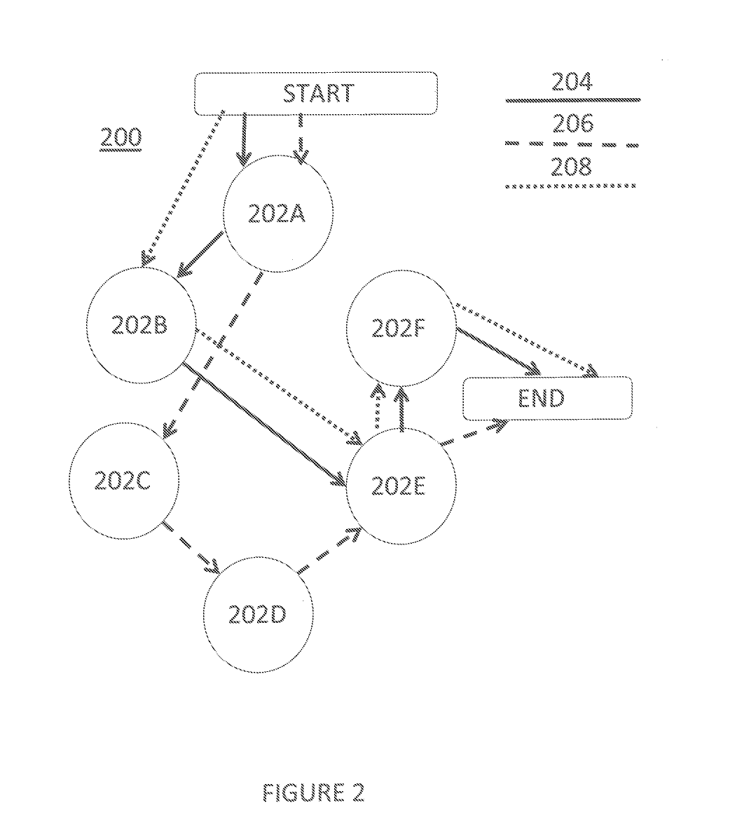

Referring to FIG. 2, shown is a simplified diagram of a video course supporting pathways. A video course 200 comprising video segments 202A-202E is shown, but there are many ways to go through the video course 200, such as via pathways 204, 206, and 208, some pathways including different video segments from other courses (not shown). In the end, a student can learn the material in any of a number of different or supplemental ways. For example, pathway 204 comprises segments 202A, 202B, 202E and 202F, respectively. Pathway 206 comprises segments 202A, 202C, 202D, and 202E. Pathway 208 comprises segments 202, 202D and 202E, respectively. A student's previous knowledge level, way of learning, as well as other factors, influence the pathway a student takes to successfully complete the video course 200. The student need not watch all of the segments to complete video course 200 and to be considered to have the same level of knowledge as other students who have completed the video course 200.

Still referring to FIG. 2, a first student views segment 202A. A pathway selected for the student is based on various different factors, a specific and non-limiting example of which is previous knowledge. A quiz is offered during or after segment 202A and based on the results of the quiz given in 202A the student is then directed to view 202B. To the student, 202B is the next segment in the course and the student may even assume that all other students move from 202A to 202B. The first student's results from the quiz given at 202B indicate that the first student has sufficient knowledge such that the first student other than has to view segments 202C and 202D. Thus, the first student views segments 202E and 202F to complete the course and pathway 204. Optionally, video segments for remediation are recommended to the student when the results from the quiz given at 202B are insufficient to move forward.

Alternatively, students choose the pathways they wish to take. In this example, the student is other than quizzed at 202B, however the student chooses to proceed to watch video segment 202E next, bypassing video segments 202C and 202D based on criteria, a specific and non-limiting example of which is video segment descriptions. Optionally, the pathway that the student follows is randomly chosen.

A second student follows pathway 206, wherein based on various different factors, such as previous knowledge or learning style, views segment 202A. Next, based on the results of the quiz given in 202A the student other than views segment 202B, but instead is directed to view segments 202C and 202D. Perhaps segment 202B comprises teachings of a topic at a very fast pace whereas segments 202C and 202D combined teach the same topic at a slower pace, in more detail, or in a completely different style. The second student's results of the quiz at the end of segment 202A indicate that the second student would have a better chance to learn the topic if the second student viewed both 202C and 202D instead of 202B. Next, the second student views segment 202E. The second student's results of the quiz at the end of segment 202E indicate that the second student has adequate knowledge of the course and need not view segment 202F. Optionally, video segments are recommended to the second student based on the results from the quizzes given in previous video segments.

Alternatively, students choose the pathways they wish to take. In this example, the second student is other than quizzed at 202a, however the student chooses to proceed to watch video segments 202C and 202D next, bypassing video segments 202B based on criteria, a specific and non-limiting example of which is video segment descriptions and ratings thereof. Optionally, the pathway that the student follows is randomly chosen.

A third student follows path 208 based on various different factors, such as previous knowledge, and skips viewing segment 202A proceeding instead to watch segment 202B. The third student's results of the quiz given at the end of 202B indicate that third student other than has to view segments 202C and 202D. The third student was very competent in the topic of segment 202B and did not require the slower paced segments 202C and 202D to remediate their knowledge of the topic. The third student proceeds to view segments 202E and 202F based upon the results of quizzes taken and knowledge assessed. Optionally, video segments are recommended to the third student based on the results from the quizzes given at video segments.

Alternatively, students choose the pathways they wish to take. In this example, the third student is other than quizzed at 202B, however the student chooses to proceed to watch video segment 202E next, bypassing video segments 202B and 202D based on criteria, a specific and non-limiting example is video segment descriptions. Optionally, the pathway that the student follows is randomly chosen.

All three students are considered to have passed course 202 although each student took a different pathway and watched different video segments of the course 202. Some courses could have very complex pathways and some may cross over to other courses to remediate any knowledge that may be missing from a student's knowledge base.

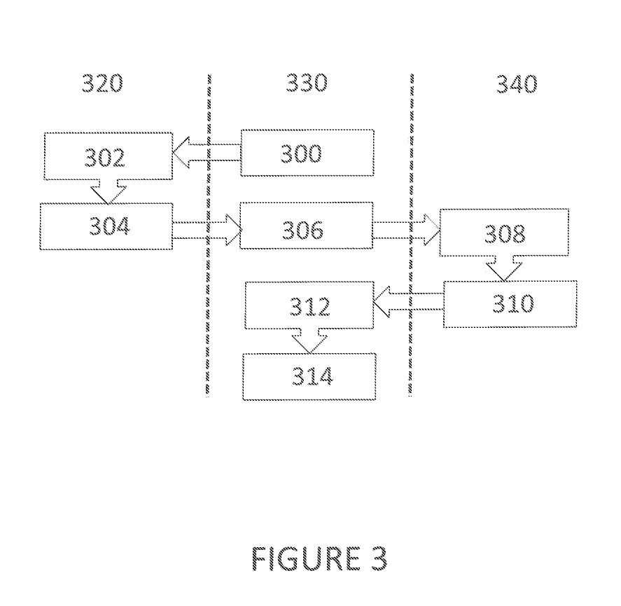

Referring to FIG. 3, shown is a simplified flow diagram of a method of switching between pathways. A student decides to watch an online video course that teaches how to design and create a dress from scratch 330. At 300, the student watches the 1^{st} segment wherein at the end of the 1^{st} segment the student is quizzed. The quiz results determine that the student, although artistic, has little to no knowledge of how to sketch clothing. Instead of progressing to another segment within the “dress design” course, the next segment shown to the student is a single segment teaching “fashion sketching” of a general arts course 320 at 302. At 304 the student successfully passes the quiz at the end of the “fashion sketching” segment and the student is directed back to a next recommended segment in the “dress design” course. At 306 the student is quizzed at the end of another segment wherein the quiz results determine that the student has knowledge of sewing, however does not know how to properly sew in a zipper. Once again, instead of progressing to another segment within the “dress design” course, the next lecture shown to the student is a single lecture teaching “zipper sewing” in a basic sewing course 340 at 308. At 310, the student successfully passes the quiz at the end of the “zipper sewing” segment and the student is directed back to the next recommended segment in the “dress design” course. Alternatively, if the student fails the quiz, the student is shown another segment within the sewing basics course that teaches material the student lacks knowledge thereof. At 312, the student is shown a plurality of video segments from the “dress design” course in an order determined by the results of quizzes at the end of each video segment. Optionally, the student other than views all of the segments in the “dress design” course if quiz results deem it unnecessary to have the dress design knowledge the course seeks to impart. Finally, at 314, the dress is almost complete and the student watches the final segment of the “dress design” course, which teaches how to hem a dress to an appropriate length for a wearer thereof. Alternatively, if the student does not fail any of the quizzes the recommended pathway to complete the course is optimized for time. There are many pathways through a course that can include multiple segments from various courses from various sources. A different online video course provider often provides video segments recommended to students that are not part of the original course. Further, students themselves could recommend video segments for specific skill improvement. These video segments could then be evaluated based on student performance and learning types of those students or other statistical metrics and a given student could receive a notification of a value of a video segment tailored to their statistical group.

Alternatively, students choose the pathways they wish to take. In this example, the student is other than quizzed at video sections. The student chooses to the watch a next video segment based on a criteria, a specific and non-limiting example is video segment descriptions. Optionally, the pathway that the student follows is randomly chosen.

When a student selects a pathway, the existence of the pathways through the material ensure that the student is still offered all the material in a meaningful fashion to gain the knowledge the course seeks to impart.

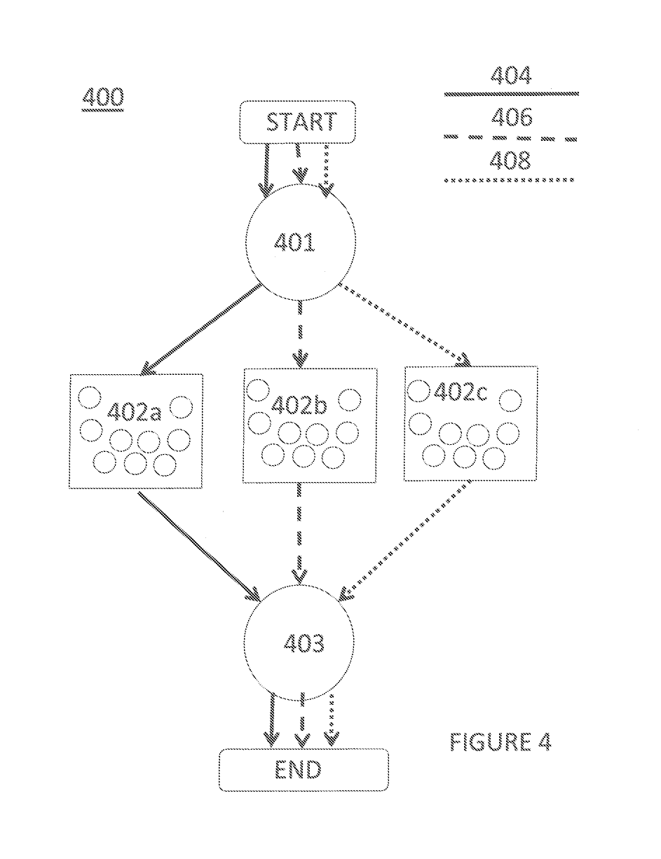

Now referring to FIG. 4, shown is a course diagram comprising multiple pathways and a student's recommended pathway is based on a condition. Optionally, the condition is unrelated to the student. For example, sailing course 400 comprises 3 sub-courses, sub-course 402a on pathway 404, 402b on pathway 406 and 402c on pathway 408. A student views the first segment 401 wherein at the end of the segment the student is quizzed about the location of the body of water in which the student plans to sail. If the student plans to sail in cold ocean waters the student is directed down pathway 404 comprising sub-course 402a which further comprises segments specific to sailing in a cold ocean. If the student plans to sail in warm ocean waters the student is directed down pathway 406 comprising sub-course 402b which further comprises segments specific to sailing in a warm ocean. If the student plans to sail in a lake the student is directed down pathway 408 comprising sub-course 402c which further comprises segments specific to sailing in a lake. Finally, once the student has completed one of sub-course 402a, 402b or 402c, the student is directed to the last segment 403 in course 400 to complete the course. Alternatively, there is other than a last segment in course 400. Instead, the student completes the last segment in one of sub-course 402a, 402b or 402c. Optionally, if the student does not fail any of the quizzes in any of sub-course 402a, 402b or 402c the recommended pathway to complete the course is optimized for time.

Of course, when the student seeks to switch to a different body of water, their knowledge gained in the course taken is known and the follow up course contains those lessons not taught in the previous pathway. Optionally, some basic skills are also refreshed in the follow up course.

Alternatively, students choose the pathways they wish to take. In this example, the student is other than quizzed at video sections. The student chooses to the watch a next video segment based on a criteria, a specific and non-limiting example is video segment descriptions and where the student intends to operate a boat. Optionally, the pathway that the student follows is randomly chosen.

As the number of students that participate in a course increases, more data is accumulated. With a sufficient amount of data collected about the success of students following different pathways, those pathways and their correlation to certain statistical models of students can be rated. Pathway ratings indicate the probability of success that a student will pass the course if the student follows that pathway. When knowledge about a student's learning patterns—statistics—are known, the pathway ratings are tailored to the student or to those learning patterns. Alternatively, the pathway rating indicates the optimal time it takes for a student to complete a course successfully. Alternatively, the pathway rating indicates another generalized characteristic of a pathway based on data collected.

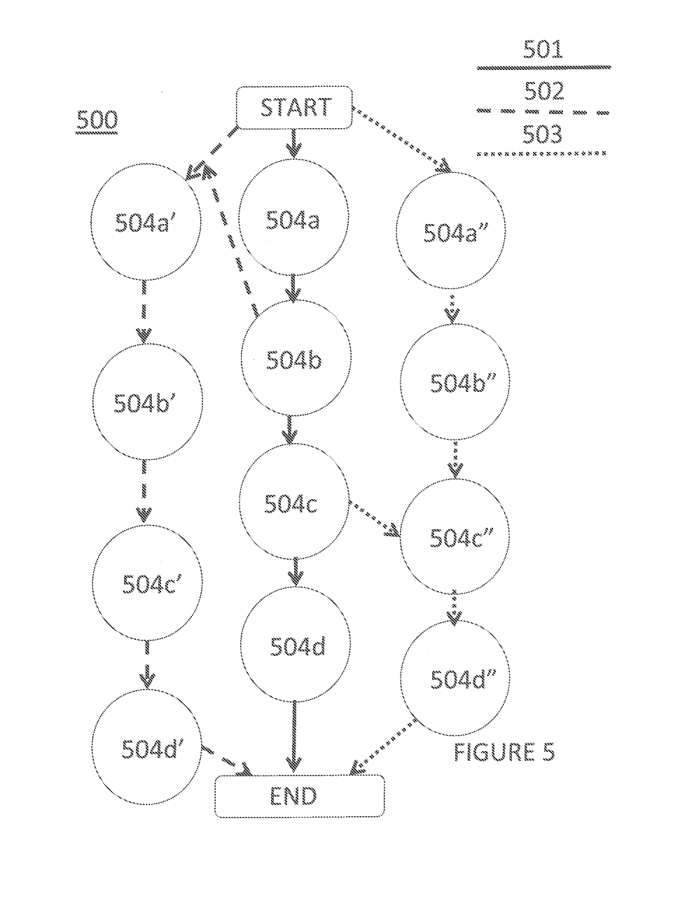

Referring to FIG. 5, shown is a simplified video course segment diagram comprising three different pathways. Every pathway has a rating, wherein the rating indicates the probability that a student will pass the course if they follow a particular pathway. In this example, pathway 501 has a rating of 6/10 wherein 60% of students that follow pathway 501 pass course 500. Pathway 502 is rated with a rating of 2/10 wherein 20% of the students that follow pathway 502 pass the course 500. Pathway 503 has a rating of 1/10 wherein 10% of the students that follow pathway 503 pass the course. Of course a student that participates in online video course 500 chooses to follow the pathway that has the highest rating of success—pathway 501 with a rating of 6/10. Optionally, the ratings relate to the student learning pattern. For example, based on video segments that were most successful at imparting knowledge to the student, and looking for other students having similar learning patterns, it is possible to estimate which learning pathway is likely to be most successful for this particular student. Alternatively, there are many more pathways that can be taken to complete the course, that optionally include video segments from other courses (not shown for clarity).

Referring again to FIG. 5, the student chooses pathway 501, as that pathway offers the highest chance of passing course 500. Alternatively, the student chooses any of the two other pathways, 502 or 503. However, should the student get low marks on the quizzes given in video segments on pathway 501, the student is switched over to pathway 502 in an effort to remediate the student's knowledge of the video segments' topics. For example, if the student gets poor results on both quizzes given after each video segment 504a and 504b, the student is switched over to the beginning of pathway 502 wherein the topic of each video segment is of pathway 502 is taught with a different style in comparison to the style taught in each segment of pathway 501. Further, if a student is successful with the quizzes given at the end of each of the segments 504a, 504b, however the results of the quiz after video segment 504c are poor, the student is redirected to follow pathway 503 to view segment 504c, wherein the segments of pathway 503 is taught by a different teacher employing a different teaching style. As different teachers have different teaching styles and every student learns differently, another teacher may be a more effective instructor for a particular student. Alternatively, the student chooses the pathway based on the instructor or the teaching style. The student may have had success with courses taught by the instructor of segments in pathway 503, thus the student follows pathway 503 from the start.

Alternatively, students choose the pathways they wish to take. In this example, the student is other than quizzed at video sections. The student chooses to the watch a next video segment based on a criteria, a specific and non-limiting example is video segment descriptions and teaching styles. Optionally, the student chooses to switch to different pathways based on a self-evaluation of their comprehension of the video segment just viewed. Optionally, the pathway that the student follows is randomly chosen.

According to an embodiment, a student that self-remediates by seeking out other video segments to improve their knowledge of a topic are automatically monitored and video segments watched by the student are recorded. For example, a physics student is viewing an electromagnetic course. In one video segment of the electromagnetic course, the physics student is quizzed, however they fail the quiz. The physics student realizes that their weakness is “imaginary numbers”. Thus, the student searches for “imaginary numbers” video segments to remediate their knowledge. For example, the student explores other online courses provided by the same online school, other online schools, websites, YouTube® and other sources. Ultimately, the student watches a first video segment teaching “imaginary numbers” from the same online school. Next, the student attempts the quiz again, however fails. An indication that the student watched the first video segment and failed the quiz is stored on a server. Next, the student watches a second video segment teaching “imaginary numbers” from a different online school. The student attempts the quiz again, however fails again. An indication that the student watched the second video segment and failed the quiz is stored on the server. Finally, the student watches a third video segment teaching “imaginary numbers” from YouTube®. The student attempts the quiz for the fourth time and passes the quiz. An indication that the student watched the third video segment and passed the quiz is stored on the server. The first, second and third video segments' viewing information is provided to future students that also fail the electromagnetic video quiz or that get the same questions on the electromagnetic video quiz wrong, so that the future students can optionally view one, two or all of the first, second and third video segments. Optionally, an indication that the physics student passed the quiz successfully after they viewed the video segment from YouTube® is also provided to future students, so that they can decide which of the video segments they think would be most helpful.

As the number of students participate in a course increases, data is accumulated. With enough data collected, correlations between quiz results and the pathway that provides the best outcome for students are made. For example, after the end of a video segment a quiz is given to students. Over time, it becomes clear that students that answer all three questions of the quiz correctly are recommended to follow pathway 1 to optimize their learning experience. Those students that answer two out of the three questions correctly are recommended to follow pathway 2 to optimize their learning experience. Students that answer one question on the quiz are recommended to follow pathway 4 and finally those students that answer no questions on the quiz correctly are recommended to follow pathway 5 as well. For quizzes with many questions, this may result in significant improvement in overall learning.

Alternatively, a grouping of specific correct/incorrect answers is correlated to certain pathways. For example, students that answer questions 1 and 2 of the quiz correctly are recommended to follow pathway 6 as it has been correlated through data collection that pathway 6 will optimize the student's learning. Students that answer questions 1 and 3 of the quiz are recommended to follow pathway 7, and so on. Based on the combination of correct/incorrect answers given by the student, the pathway that provides the greatest opportunity of success is recommended to the student. As the number of questions in the quiz increases, the statistics and correlation is both more difficult to form without large student populations and methodical data gathering. That said, the predictive abilities increase with greater granularity of the statistical data.

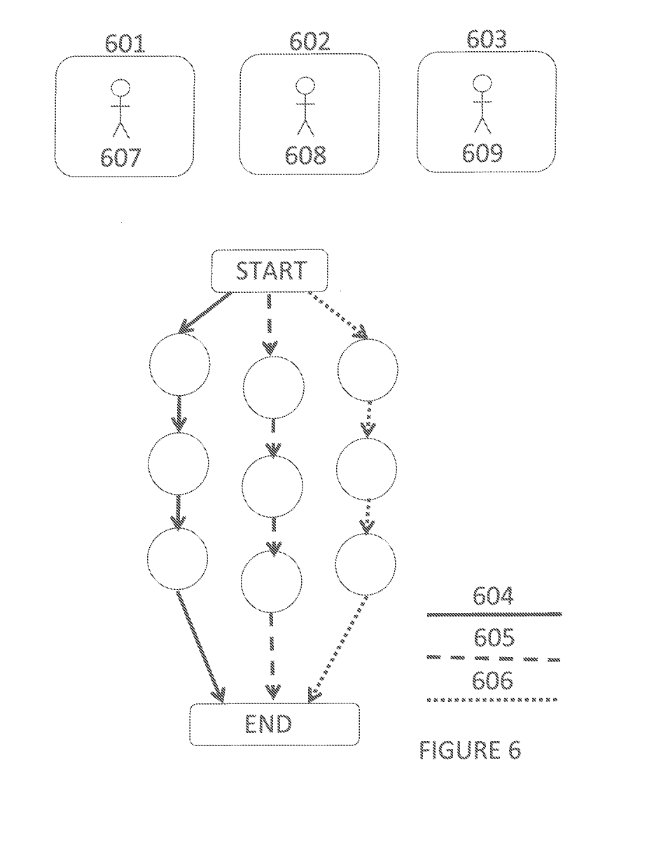

As a plurality of students participate in high numbers of online video courses sufficient data is collected such that students can be categorized into groups based on their past performance as well as segment specific data. Each group has particular characteristics, a specific and non-limiting example of group type is based on learning style. In the past, students of a defined group had the greatest success of passing a course if they followed a particular pathway. For example, in FIG. 6, shown is another simplified video course segment diagram comprising a plurality of different pathways. Large amounts of online video course data have been collected by a server and groups of students with similar characteristics are identified. Such as group 601, wherein the students within the group are noted to learn best by auditory learning—listening to explanations from the instructor. Students in group 602 are noted to learn the best by concept abstraction. Finally, students in group 603 are noted to learn best by way of example. Each group is correlated to a particular pathway for course 600, the pathway that offers the greatest possibility of a student within the defined group to pass course 600. For example, students in group 601 are recommended to follow pathway 604 wherein the video segments in pathway 604 comprise detailed verbal explanations of the subject by the instructor. Students in group 602 are recommended to follow pathway 605 wherein the segments in pathway 605 comprise lectures by an instructor presenting abstract concepts. Finally, students in group 603 are recommended to follow pathway 606 wherein the video segments in pathway 606 comprise lectures by an instructor that provide many examples to teach the subject matter. Some of the subject matter and video segments are identical between pathways, though this need not be so, as sometimes a demonstration is helpful or an introduction to a concept is helpful regardless of learning style.

Performance history of students 607, 608 and 609 is recorded and stored on a server. Based on the performance history, video segment information and other online video data, the server associates students 607, 608 and 609 with one of the defined groups. For example, student 607 is associated with group 601, student 608 is associated with group 602 and student 609 is associated with group 603, and are thus recommended to follow pathways 604, 605 and 606, respectively. Alternatively, the student chooses the pathway based on criteria, for example the group in which they are binned. Optionally, the student chooses the pathway based on criteria, such one of pathway descriptions or video segment descriptions.

As a plurality of students participate in high numbers of online video courses, data is collected about each student, for example, data characterizing the student's past performance, learning style, successful pathways followed, etc. Each student is added to a lookup table wherein the student is associated with a plurality of characteristics. As data is collected over time for a new student, that new student is also added to the lookup table. Students in the lookup table are also associated with each other based on similar characteristics. The student-to-student correlations are used to recommend pathways for a given student. Though this is a more extreme form of binning, it allows for a level of recommendation that is quite student specific given sufficient pathways, remediation video segments, and so forth.

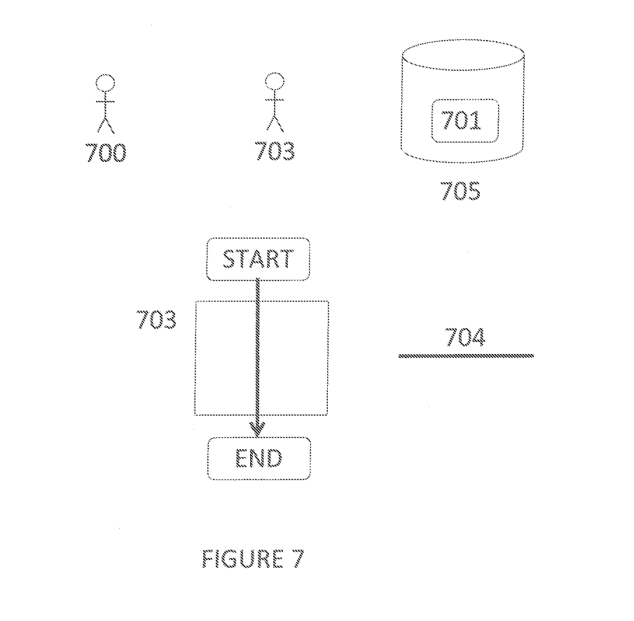

Shown in FIG. 7, is a simplified diagram of a video course according to an embodiment of the invention. For example, student 700 is a long time student of online video courses and is populated in lookup table 701 along with data characterizing the student 700 stored in server 705. Student 702 has answered the same video segment questions correctly as student 700 in most of the courses student 702 and student 700 have both studied, though at different times. As a result, student 702 is associated with student 700 in the lookup table 701. Student 702 decides to study course 703, which contains a plurality of pathways. Using lookup table 701, server 705 recommends to student 702 to follow the same pathway 704 through course 703 as was taken successfully by student 700. Due to the overlap of similar questions successfully answered by both students 700 and 702 in previous courses, it is predicted that student 703 has a high likelihood of passing course 703, if pathway 704 is followed. Alternatively, student 702 chooses the pathway 704 based on criteria, such as his commonality with student 703. Optionally, other student-to-student correlation include for example, but are not limited to, learning style, preferred instructor, similar types of mistakes made, and performance time. Optionally, students may enter personal information such as level of education, educational institutions attended, gender, age, skill set, interests, favorite subjects, known learning disabilities, profession(s), etc. that are also be used for student-to-student correlation.

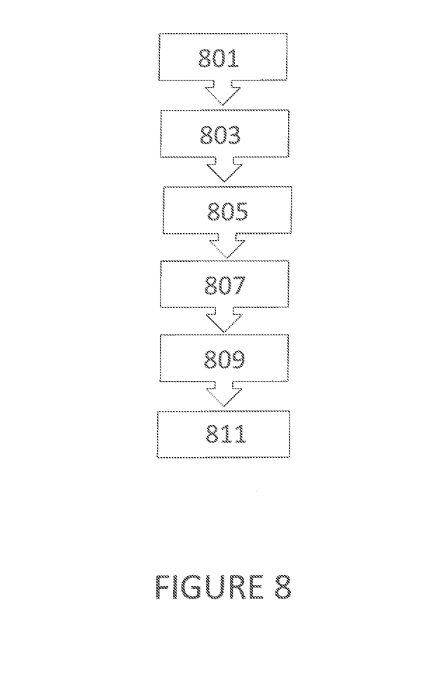

Shown in FIG. 8, is a simplified flow diagram of students dynamically adding new pathways to a course and associating a rating to the new pathway. For example, at 801 a student is viewing a video segment of a fishing course. The topic of the video segment is tying flies. The student other than finds the segment to be helpful in their understanding of tying flies and associates the pathway segment with a low rating at 803. The student seeks out another video segment or optionally multiple video segments on the Internet at 805 that would better educate the student on the topic of tying flies. The student views alternative video segments and finds a plurality of video segments, that if watched consecutively, would provide excellent instruction on fly tying at 807. The student links the segments together and adds the linked segments to the fishing course at 809. At 811, the student rates the new pathway so created by adding the linked segments to the fishing course. The new pathway bypasses the original segment about fly tying. Later, other students that view the fly fishing course have access to pathway ratings of pathways in the fly fishing course and also have the ability to rate the pathways. Future students have access to all of the ratings and can use the ratings as a guide to the best pathway. Optionally, students can add reviews of the pathways, adding comments about the pathways, such that other students can read before they view the course.

Alternatively, a student finds a portion of a video segment highly informative but other portions lacking. The student finds alternative sub-segments and splices portions of video segments together to improve the overall educational quality of the video segment. The newly spliced together video segment is added to a new pathway of a course. Alternatively, the segments are mapped together forming multiple parallel pathways or pathway portions.

Alternatively, student ratings, etc. are correlated to form a correlation between students. Further alternatively, students are correlated by actual performance metrics. For example, a first student is provided pathways ratings provided by a second student to which the first student is highly correlated. The first student would naturally follow the pathways rated highly by the second student.

According to an embodiment, student performance history is accumulatively stored and repetitive mistakes or fault patterns are identified and brought to the student's attention. Remedial courses or video segments are recommended to the student to overcome any deficiency of knowledge. Thus, student focused remediation is supported. Further, courses that were successful for other students with similar shortcomings are more often recommended such that shortcomings do not greatly adversely affect education.

According to an embodiment, a student of an online video course is provided with information for directing the student to more detailed information about the topic of the video segment/course they are watching. A specific and non-limiting example is an online American History course. Each video segment teaches at least one important event/person/era in America's past. While watching a video segment in the American History course that teaches about the Civil War, an indication is provided to the student that there are many more non-compulsory video segments or entire courses available for learning about the Civil War should the student wish to learn more about the subject than what is taught in the current video segment. For example, a link appears at the bottom of the Civil War video segment that directs the student to a webpage that contains links for other video segments/courses on the Civil War. As these video segments/courses are non-compulsory, the student can indulge in interest based learning as opposed to strict curriculum based learning. Optionally, the extraneous video segments/courses are from the same online school, other online schools, websites, YouTube® and other sources. Optionally, when the courses are accredited, taking a course, so suggested results in further credits toward an overall education. In this way, a student may end up taking 5 history courses instead of one but in a purely interest driven fashion.

Numerous other embodiments may be envisaged without departing from the scope of the invention.

Having thus described the invention, it is now claimed:

1. A method comprising:
providing a first plurality of video segments and a second plurality of video segments to form a course, wherein the first plurality of segments is absent at least one video segment of the second plurality of video segments;
arranging the first plurality of video segments sequentially to form a first pathway for teaching first material;
arranging the second plurality of video segments sequentially to form a second pathway for teaching same first material, the second pathway including at least one video segment within the first pathway;
providing the course to a first user comprising displaying the first pathway to the first user; and
providing the course to a second user comprising displaying the second pathway to the second user.

2. The method according to claim 1 comprising dynamically arranging the first plurality of video segments sequentially to form the first pathway, wherein the order of each video segment in the sequence is determined after the preceding video segment in the sequence is displayed.

3. The method according to claim 2 comprising arranging the first plurality of video segments in the first pathway based on results provided by the first user to questions proposed in at least one video segment of the first pathway.

4. The method according to claim 1 comprising arranging the first plurality of video segments in the first pathway by the first user.

5. The method according to claim 1 wherein a combination of a first video segment and a second video segment of the first pathway teach the same material as a third video segment of the second pathway.

6. The method according to claim 1 comprising:
providing a third plurality of video segments comprising at least one video segment from the first pathway and one video segment from the second pathway to form the course;
arranging the third plurality of video segments sequentially to form a third pathway; and
providing the course to a third user comprising displaying the third pathway to the third user.

7. The method according to claim 6 comprising switching the third user from the third pathway to the first pathway in dependence upon performance of the third user within the course.

8. The method according to claim 6 wherein the third pathway comprises the first video segment of the first pathway or the third video segment of the second pathway, but other than comprises both.

9. The method according to claim 2 comprising displaying a portion of the first pathway and a portion of the second pathway to a fourth user, the portions dynamically determined during the course.

10. The method according to claim 9 wherein the portion of the first pathway and the portion of the second pathway displayed to the fourth user are selected by the fourth user.

11. The method according to claim 9 wherein the portion of the first pathway and the second pathway displayed to the fourth user are based on results provided by the fourth user to questions proposed in at least one video segment of either the first pathway or the second pathway.

12. The method according to claim 9 wherein the portion of the first pathway and the second pathway displayed to the fourth user is based on a course variable.

13. The method according to claim 1 comprising:
displaying a portion of the first pathway to a fifth user;
viewing a new video segment by the fifth user to remediate the fifth user's knowledge of a recent video segment of the first pathway displayed to the fifth user;
adding the new video segment to the course; and
forming a fourth pathway comprising the new video segment.

14. The method according to claim 13 comprising:
storing in a data store an indication of viewing the new video by the fifth user; and
switching users to the fourth pathway in dependence upon their performance on the recent video segment.

15. The method according to claim 1 comprising:
displaying a portion of the first pathway to a fifth user;
viewing a new video segment by the fifth user to remediate the fifth user's knowledge of a recent video segment of the first pathway displayed to the fifth user;
adding the new video segment to the course; and
modifying the first pathway to include the new video segment.

16. The method according to claim 15 wherein the new video segment is added to a course pathway with a rating by the fifth user.

17. The method according to claim 1 wherein providing the course to the first user is based on a course variable.

18. A method comprising:
providing a plurality of students including a first student and first group of students;
providing a plurality of courses in a video format and comprising a plurality of video segments, at least some of the courses having more than one pathway each comprising at least a different video segment;
for each of the plurality of students, storing data relating to performance on each of a plurality courses; and
determining one of at least two pathways for teaching a same course to a first student, the one of at least two pathways determined based on historical performance of a first group of students on the one of at least two pathways, the first group of students similar to the first student.

19. A method comprising:
providing a plurality of students including a first student and first group of students;
providing a plurality of courses in a video format and comprising a plurality of video segments, at least some of the courses having more than one pathway each comprising at least a different video segment;
for each of the plurality of students, storing data relating to performance on each of a plurality courses;
viewing a course by a first student; and
determining at least a first remediation video segment for the course for the first student, the remediation video segment determined based on historical performance of a first group of students in the course, the first group of students similar to the first student.
